(19) United States
(12) Patent Application Publication
(10) Pub. No.: US 2017/0045862 A1
(43) Pub. Date: Feb. 16, 2017

(54) METHOD AND DEVICE FOR MANAGING ALARM CLOCK, ELECTRONIC DEVICE

(71) Applicant: Xiaomi Inc., Beijing (CN)

(72) Inventors: Weiguang JIA, Beijing (CN); Qiang FU, Beijing (CN); Enxing HOU, Beijing (CN)

(21) Appl. No.: 15/234,110

(22) Filed: Aug. 11, 2016

(30) Foreign Application Priority Data
Aug. 13, 2015 (CN) 201510497767.4

(51) Int. Cl. G04G 13/02; G04G 21/02; H04W 76/02

(52) U.S. Cl. CPC G04G 13/023; H04W 76/023; G04G 21/025

(57) ABSTRACT

The present disclosure relates to a method and a device for managing an alarm clock. The method includes: acquiring a movement of a user; and cancelling a prompt preset in the alarm clock if the user is in a moving state when it is time to execute the prompt.

### CROSS-REFERENCE TO RELATED APPLICATIONS

This application is based upon and claims a priority to Chinese Patent Application No. 201510497767.4, filed on Aug. 13, 2015, the entire content of which is incorporated herein by reference.

### TECHNICAL FIELD

The present disclosure generally relates to the field of smart home technology and, more particularly, to a method and a device for managing an alarm clock.

### BACKGROUND

An alarm clock is an essential tool for people's daily life. The alarm clock may enable a user to wake up in time by presetting a time to execute a prompt, so as to prevent a time-sensitive plan (e.g., going to school, going to work, going out) from being delayed.

Sometimes, a user may wake up around a preset time to execute a prompt without the alarm clock because a “bioclock” has been formed with daily work and life habits. However, the alarm clock in the related art still gives the prompt according to the preset time, which may conversely disturb the user, in particular those in a bad mood after waking up in the morning.

### SUMMARY

According to a first aspect of embodiments of the present disclosure, there is provided a method for managing an alarm clock, including: acquiring a movement of a user; and cancelling a prompt preset in the alarm clock if the user is in a moving state when it is time to execute the prompt.

According to a second aspect of embodiments of the present disclosure, there is provided a device for managing an alarm clock, including: an acquiring unit, configured to acquire a movement of a user; and a first cancelling unit, configured to cancel a prompt preset in the alarm clock if the user is in a moving state when it is time to execute the prompt.

According to a third aspect of embodiments of the present disclosure, there is provided an electronic device, including: a processor; and a memory for storing instructions executable by the processor. The processor is configured to, when executing the instructions stored in the memory: acquire a movement of a user; and cancel a prompt preset in the alarm clock if the user is in a moving state when it is time to execute the prompt.

It is to be understood that both the foregoing general description and the following detailed description are illustrative and explanatory only and are not restrictive of the disclosure, as claimed.

### BRIEF DESCRIPTION OF THE DRAWINGS

The accompanying drawings, which are incorporated in and constitute a part of this specification, illustrate embodiments consistent with the disclosure and, together with the description, serve to explain the principles of the disclosure.

FIG. 1 is a flow chart showing a method for managing an alarm clock according to an illustrative embodiment.

FIG. 2A is a schematic diagram showing an alarm clock according to an illustrative embodiment.

FIG. 2B is a schematic diagram showing an application scenario of a method for managing an alarm clock according to an illustrative embodiment.

FIG. 3 is a flow chart showing another method for managing an alarm clock according to an illustrative embodiment.

FIG. 4A is a schematic diagram showing an alarm clock and a detecting device according to an illustrative embodiment.

FIG. 4B is a schematic diagram showing an application scenario of another method for managing an alarm clock according to an illustrative embodiment.

FIG. 5 is a flow chart showing a further method for managing an alarm clock according to an illustrative embodiment.

FIG. 6 is a schematic diagram showing a detecting device according to an illustrative embodiment.

FIGS. 7 to 10 are block diagrams each showing a device for managing an alarm clock according to an illustrative embodiment.

FIG. 11 is a schematic diagram showing a device for managing an alarm clock according to an illustrative embodiment.

### DETAILED DESCRIPTION

Reference will now be made in detail to illustrative embodiments, examples of which are illustrated in the accompanying drawings. The following description refers to the accompanying drawings in which the same numbers in different drawings represent the same or similar elements unless otherwise represented. The implementations set forth in the following description of illustrative embodiments do not represent all implementations consistent with the disclosure. Instead, they are merely examples of apparatuses and methods consistent with aspects related to the disclosure as recited in the appended claims.

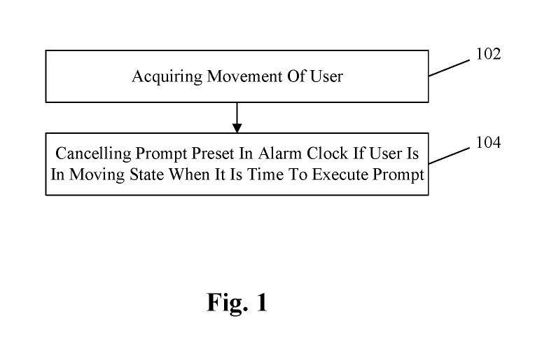

FIG. 1 is a flow chart showing a method for managing an alarm clock according to an illustrative embodiment. Referring to FIG. 1, the method is used in an alarm clock or a mobile device having a function of an alarm clock, and includes the following steps.

In step 102, a movement of a user is acquired.

In an illustrative embodiment, the movement of the user may be detected directly by a movement sensor disposed in the alarm clock, thereby decreasing complexity of achieving the technical solution of the present disclosure.

In another illustrative embodiment, the movement of the user may be acquired by establishing a wireless communication with a device equipped with a movement sensor, and receiving an indication of the movement of the user detected by the movement sensor via the wireless communication, thereby decreasing structural complexity of the alarm clock in this embodiment.

In step 104, a prompt preset in the alarm clock is cancelled if the user is in a moving state when it is time to execute the prompt.

In the present embodiment, the step of cancelling the prompt is performed only on the very day when the user is in the moving state and it is time to execute the prompt. For example, if the time to execute the prompt is 07:00, then the prompt to be executed at 07:00 is cancelled on that very day when the user is in the moving state at 07:00, instead of no longer executing the prompt.

Further, in one embodiment, the time to execute the prompt may be delayed for a predetermined time period to create a corresponding delayed prompt, and the movement of the user may be periodically acquired within the predetermined time period. For example, if the time to execute the initial prompt is 07:00, and the predetermined time period is 5 minutes, then the time to execute the corresponding delayed prompt is 07:05, and the movement of the user is periodically acquired between 07:00 and 07:05. In the case that it is detected that the user is constantly in the moving state from 07:00 to 07:05, the delayed prompt is cancelled. In the present embodiment, the delayed prompt is created automatically, so as to prevent the user from falling asleep again or to avoid misjudgment of the user's sleep status, thereby ensuring that the user may get up in time.

As can be seen from the above embodiments, the movement of the user is acquired to determine whether the user already wakes up on his/her own or is still asleep, so as to determine the user's demand on the prompt of the alarm clock. At the same time, the prompt of the alarm clock may be cancelled automatically so as to prevent the user from being disturbed in the case that the user already wakes up and thus the prompt of the alarm clock is undesired, thereby improving the user's experience.

In embodiments of the present disclosure, the “alarm clock” may be an independent alarm clock, or a mobile device having an alarm clock function, such as a smartphone. In order to facilitate understanding, the technical solution of the present disclosure is described in the following embodiments by taking an independent alarm clock as an example.

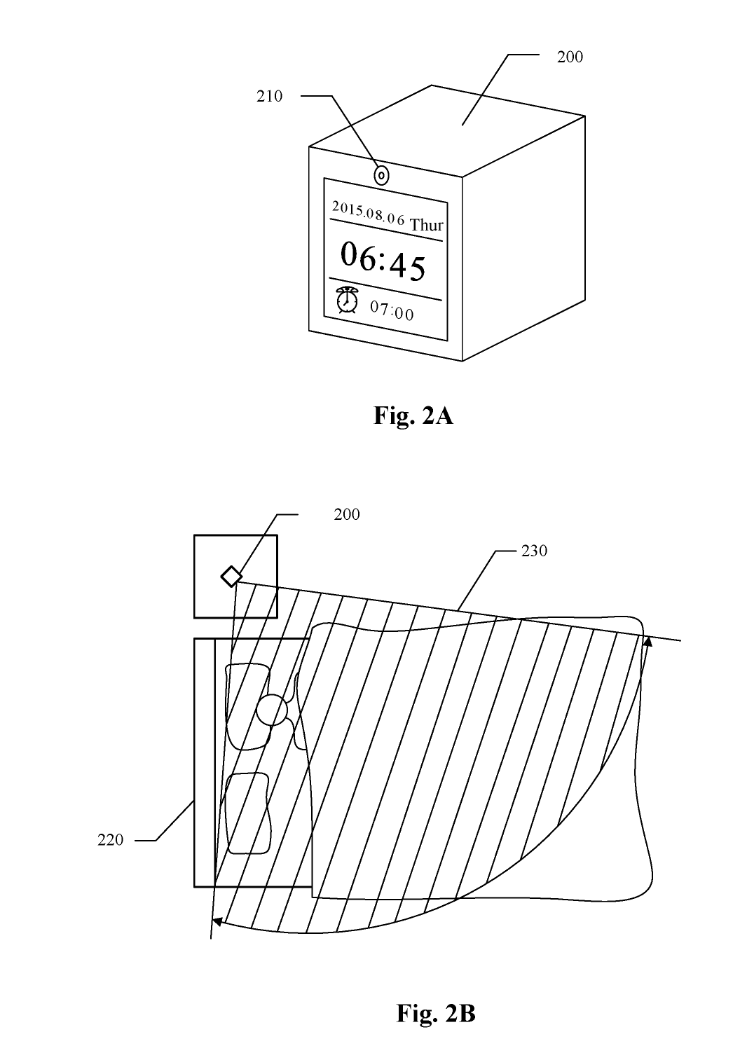

FIG. 2A is a schematic diagram showing an alarm clock 200 according to an illustrative embodiment. As shown in FIG. 2A, in the illustrative embodiment, the alarm clock 200 is provided with a movement sensor 210. Accordingly, as shown in FIG. 2B, in an application scenario of a method for managing an alarm clock, the alarm clock 200 can be placed at a side of a bed 220, so as to be capable of forming a detecting area 230 (shown as the shadow area in FIG. 2B) directly by the movement sensor 210. When the user sets the alarm clock 200, the user may set the detecting area 230 to cover a movement area of the user, such that the alarm clock 200 may directly detect the movement of the user.

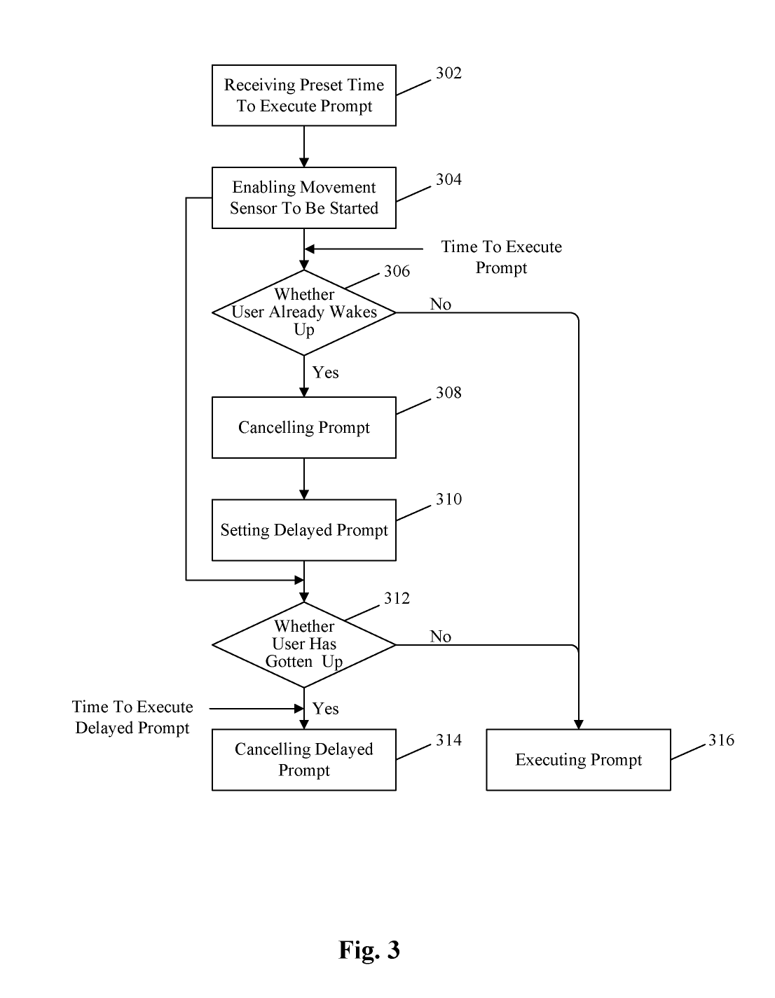

Accordingly, FIG. 3 is a flow chart showing another method for managing an alarm clock, according to an illustrative embodiment. As shown in FIG. 3, the method includes the following steps.

In step 302, the alarm clock receives a time to execute a prompt preset by a user.

For example, if the time to execute the prompt preset by the user is 07:00 every morning, then the alarm clock enables the user to wake up every morning at 07:00 by giving the prompt (such as ringing) in the related art.

In step 304, the alarm clock enables the movement sensor to be started.

In one embodiment, the alarm clock may enable the movement sensor to be maintained in an ON state in the case that the time to execute the prompt has been set. Alternatively, in another embodiment, the alarm clock may enable the movement sensor to be started at a predetermined time before the time to execute the prompt on the very day. For example, when the time to execute the prompt is set at 07:00, the alarm clock may enable the movement sensor to be started at 06:30; while the movement sensor is obviously in an OFF state at 06:00. In such manner, electricity consumption by the movement sensor may be reduced, thereby extending a standby time period of the alarm clock.

In step 306, when it is the time to execute the prompt, it is determined whether the user already wakes up based on the movement of the user detected by the movement sensor. If it is determined that the user already wakes up, step 308 is performed; otherwise step 316 is performed.

In step 308, the prompt to be executed at 07:00 is cancelled.

In the present disclosure, the movement sensor may be any sensor capable of detecting a movement of a user in the related art, which is not limited herein. By way of example, the movement sensor may be an infrared sensor, so as to detect whether the user is in the moving state by emitting and receiving an infrared signal. In order to distinguish the user's movement when the user wakes up from the user's movement during sleeping such as turning over, the movement sensor or the alarm clock may identify a level of the movement of the user. For example, it is determined that the user already wakes up only when detecting a relatively great level of the movement of the user.

In the present embodiment, the prompt is cancelled in the case that the user already wakes up, so as to prevent the user from suffering from disturbance caused by ringing of the alarm clock, particular those in a bad mood after waking up in the morning. Therefore, in the case that the user already wakes up, it is unnecessary for the alarm clock to prompt the user to wake up. In such manner, the user's experience may be improved.

In step 310, the alarm clock delays the time to execute the prompt preset in step 302 for a predetermined time period automatically, thereby creating a corresponding delayed prompt to be executed at a new time.

For example, if the predetermined time period is 5 minutes and the time to execute the prompt set in step 302 is at 07:00, then the new time to execute the delayed prompt is at 07:05.

In step 312, when it is time to execute the delayed prompt, it is determined whether the user has gotten up based on the movement of the user detected by the movement sensor. If it is determined that the user has gotten up, step 314 is performed; otherwise step 316 is performed.

In step 314, the delayed prompt is cancelled.

In step 316, the prompt is performed.

In the present embodiment, the alarm clock may misjudge the movement of the user resulting from a great level of movement during sleeping, such as turning over, or going to bathroom at night (it is possible for the user to go back to sleep again). Therefore, the cancellation of the prompt to be executed in step 308 may cause the user to be unable to get up in time in the above or other cases.

As a result, in the present embodiment, the delayed prompt is automatically set up, so as to ensure that the user gets up indeed by continuing detecting the movement of the user. The movement of the user may be periodically acquired within the predetermined time period before the time to execute the delayed prompt (e.g., during 07:00 to 07:05). The delayed prompt is cancelled if it is detected that the user is in the moving state. For example, in the case that a detecting period is 1 min, it is required that the user is in the moving state at every time the detection is performed, instead of at any time.

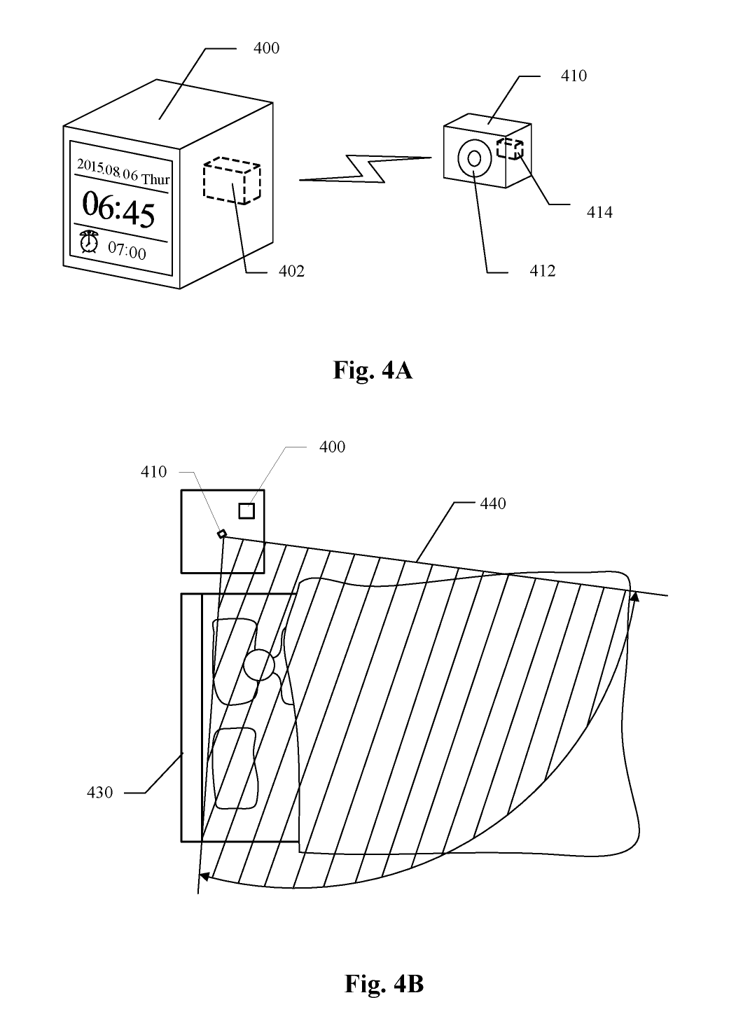

FIG. 4A is a schematic diagram showing an alarm clock 400 and a detecting device 410, according to an illustrative embodiment. As shown in FIG. 4A, in the illustrative embodiment, the alarm clock 400 is not provided with a movement sensor, thus the external detecting device 410 is desired to detect the user's movement. The detecting device 410 is provided with a movement sensor 414. The alarm clock 400 and the detecting device 410 are provided with a first communication module 402 and a second communication module 412, respectively, such that a wireless communication is established between the alarm clock 400 and the detecting device 410, and thus the alarm clock 400 can acquire the movement of the user detected by the movement sensor 414 inside the detecting device 410. The wireless communication between the alarm clock 400 and the detecting device 410 may be established in any way, such as BLUETOOTH, WIFI, and NFC. The wireless communication between the alarm clock 400 and the detecting device 410 may be a communication in a point-to-point manner, or a communication by joining in one same local area network at the same time, which is not limited herein.

Accordingly, as shown in FIG. 4B, in an application scenario of the method for managing an alarm clock, both the alarm clock 400 and the detecting device 410 may be place at a side of a bed 430, so that the detecting device 410 is able to form a detecting area 440 (shown as the shadow area in FIG. 4B) by the movement sensor 414. When the user sets the detecting device 410, the user may set the detecting area 440 to cover a movement area of the user, so that the movement of the user may be detected by the detecting device 410.

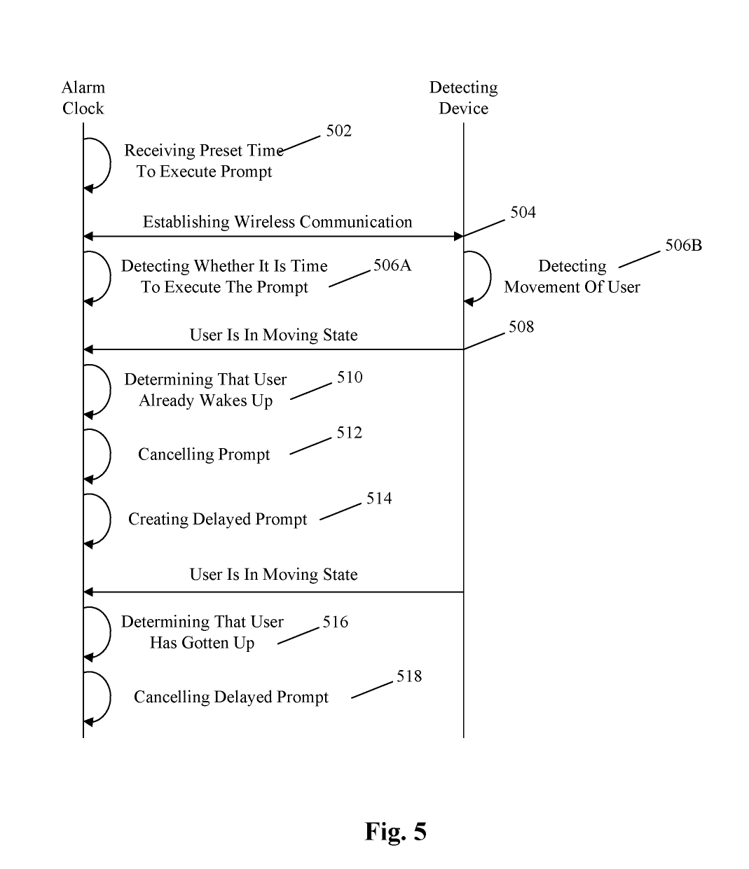

Accordingly, FIG. 5 is a flow chart showing a further method for managing an alarm clock, according to an illustrative embodiment. As shown in FIG. 5, the method includes the following steps.

In step 502, the alarm clock receives a time to execute a prompt preset by a user.

For example, if the time to execute the prompt preset by the user is 07:00 every morning, then the alarm clock enables the user to wake up every morning at 07:00 by giving the prompt (such as ringing) in the related art.

In step 504, a wireless communication is established between the alarm clock and the detecting device.

In the present embodiment, the wireless communication may be established between the alarm clock and the detecting device in any way, such as BLUETOOTH, WIFI, and NFC, which is not limited herein. The wireless communication between the alarm clock and the detecting device may be a direct communication in a point-to-point manner, or a communication by joining in one same local area network at the same time, which is not limited herein.

There is no necessary sequential order between steps 502 and 504. For example, the wireless communication may be established at first, and then the time to execute the prompt is set.

In step 506A, the alarm clock compares a current time and the time to execute the prompt, so as to determine whether it is the time to execute the prompt.

In step 506B, the detecting device detects the movement of the user. This step is similar to step 304 in FIG. 3, which is not repeated here.

There is no necessary sequential order between steps 506A and 506B.

In step 508, if it is detected that the user is in a moving state, the detecting device informs the alarm clock that the user is in the moving state.

In an alternative embodiment, the detecting device may directly inform the alarm clock of a detecting result obtained by a movement sensor in the detecting device, rather than identify the movement state of the user. Based on the detecting result received from the detecting device, the alarm clock identifies the movement state of the user, so as to determine whether the user is in the moving state.

In step 510, when it is time to execute the prompt, the alarm clock determines whether the user is in the moving state. If it is determined that the user is in the moving state, step 512 is performed; otherwise the prompt is executed.

In step 512, the alarm clock cancels the prompt to be executed at 07:00. This step is similar to step 308 in FIG. 3, which is not repeated here.

In step 514, the alarm clock delays the time to execute the prompt preset in step 502 for a predetermined time period automatically, thereby creating a delayed prompt to be executed at a new time.

For example, if the predetermined time period is 5 minutes and the time to execute the prompt set in step 502 is 07:00, then the new time to execute the delayed prompt is 07:05.

In step 516, when it is time to execute the prompt, the alarm clock determines whether the user has gotten up based on the movement of the user detected by the movement sensor in the detecting device. If it is determined that the user has gotten up, step 518 is performed; otherwise the delayed prompt is executed.

In step 518, the alarm clock cancels the delayed prompt. This step is similar to step 314 in FIG. 3, which is not repeated here.

It is noted that the alarm clock alone (as shown in FIG. 2A-2B) or along with the external detecting device which is equipped with the movement sensor (as shown in FIG. 4A-4B) is disposed at a certain distance from the user, when detecting the movement of the user. Alternatively, however, the detecting device may be in direct contact with or located adjacent to the user (e.g., a distance between the detecting device and the user is no more than a predetermined distance) on the basis that the alarm clock is spaced apart from the user, so as to detect a user's physiological feature, and acquire the movement of the user.

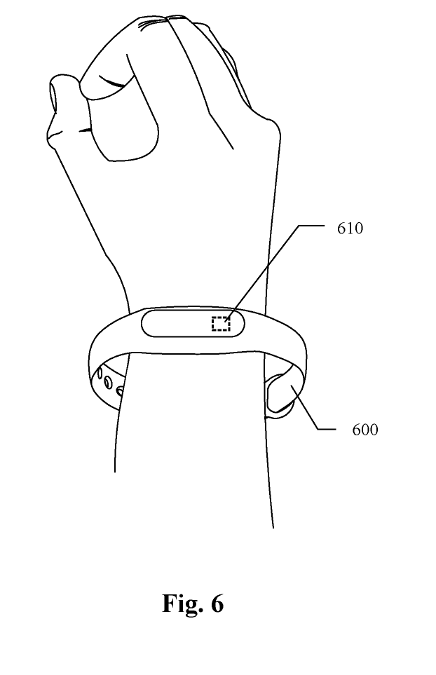

By way of example, as shown in FIG. 6, the detecting device may be a wearable device (such as a smartband 600) which is provided with a physiological parameter sensor 610, serving as the movement sensor of the present disclosure. The physiological parameter sensor 610 detects the user's physiological feature, such as heartbeat frequency, pressure value, and breath rhythm, thereby acquiring the movement of the user more accurately.

Corresponding to the method for managing the alarm clock in the above embodiment, there is provided a device for managing an alarm clock in an embodiment.

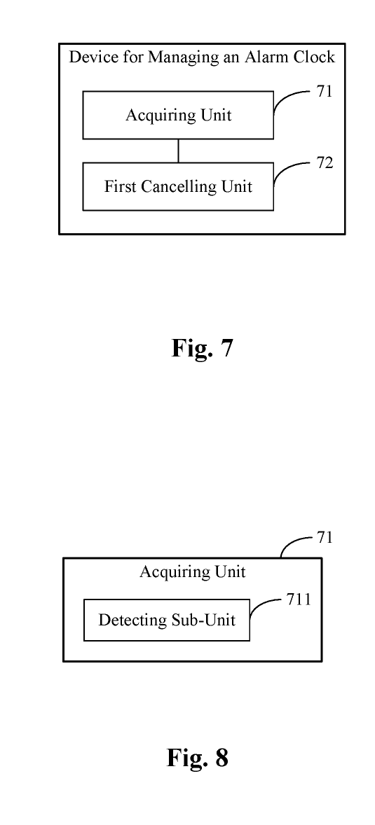

FIG. 7 is a block diagram showing a device for managing an alarm clock according to an illustrative embodiment. Referring to FIG. 7, the device includes an acquiring unit 71 and a first cancelling unit 72.

The acquiring unit 71 is configured to acquire a movement of a user.

The first cancelling unit 72 is configured to cancel a prompt preset in the alarm clock if the user is in a moving state when it is time to execute the prompt.

FIG. 8 is a block diagram showing a device for managing an alarm clock according to an illustrative embodiment. On the basis of the embodiment as shown in FIG. 7, the acquiring unit 71 may further include a detecting sub-unit 711.

The detecting sub-unit 711 is configured to detect the movement of the user by a movement sensor disposed in the alarm clock.

In one embodiment, the movement sensor includes an infrared sensor located adjacent to the user and having a sending-and-receiving window facing an area where the user is located.

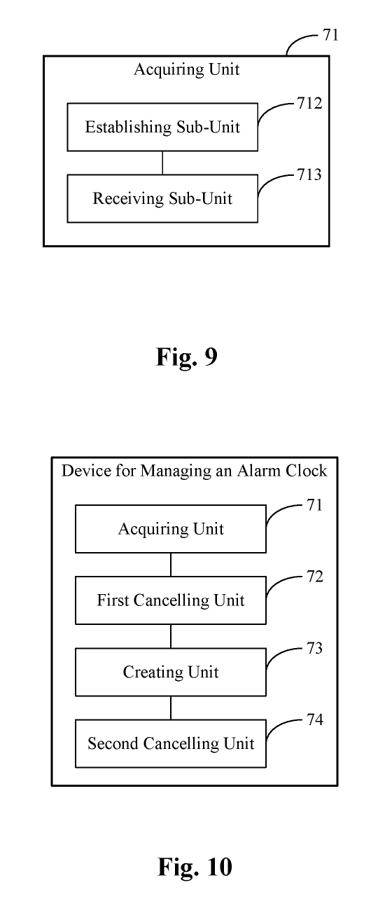

FIG. 9 is a block diagram showing a device for managing an alarm clock according to an illustrative embodiment. On the basis of the embodiment as shown in FIG. 7, the acquiring unit 71 may further include: an establishing sub-unit 712 and a receiving sub-unit 713.

The establishing sub-unit 712 is configured to establish a wireless communication with a device equipped with a movement sensor.

The receiving sub-unit 713 is configured to receive a detecting result regarding the movement of the user detected by the movement sensor via the wireless communication.

Alternatively, in the case that the device equipped with the movement sensor is a wearable device, the movement sensor includes: a physiological parameter sensor.

Alternatively, the movement sensor includes: an infrared sensor located adjacent to the user and having a sending-and-receiving window facing an area where the user is located.

FIG. 10 is a block diagram showing a yet further device for managing an alarm clock according to an illustrative embodiment. On the basis of the embodiment as shown in FIG. 7, the device may further include: a creating unit 73 and a second cancelling unit 74.

The creating unit 73 is configured to delay the time to execute the prompt for a predetermined time period and create a delayed prompt.

The second cancelling unit 74 is configured to periodically acquire the movement of the user within the predetermined time period and cancel the delayed prompt if it is determined that the user is in the moving state.

It is noted that the creating unit 73 and the second cancelling unit 74 in the device embodiment as shown in FIG. 10 may be also included in the device embodiment as shown in FIG. 8 or 9, which is not limited herein.

With respect to the devices in the above embodiments, the specific manners for performing operations for individual modules therein have been described in detail in the embodiments regarding the methods for managing the alarm clock, which will not be repeated here.

Since the device embodiments substantially correspond to the method embodiments, reference is made to description for the method embodiments as to details not disclosed in the device embodiments. The above-described device embodiments are merely for the purpose of illustration. Those units described as separated components may be or may not be physically separated; those units described as a single component may be or may not be a physically single unit, i.e., either located at one place or distributed onto a plurality of network units. The object of the present disclosure may be achieved by part or all of modules in accordance with practical requirements.

Accordingly, the present disclosure further provides in embodiments an electronic device, including a processor; and a memory for storing instructions executable by the processor. The processor is configured to: acquire a movement of a user; and cancel a prompt preset in an alarm clock if the user is in a moving state when it is time to execute the prompt.

Accordingly, the present disclosure further provides in embodiments a terminal, including a memory; and one or more programs stored in the memory, configured to be executed by one or more processors, and including the following instructions for executing: acquiring a movement of a user; and cancelling a prompt preset in the alarm clock if the user is in a moving state when it is time to execute the prompt.

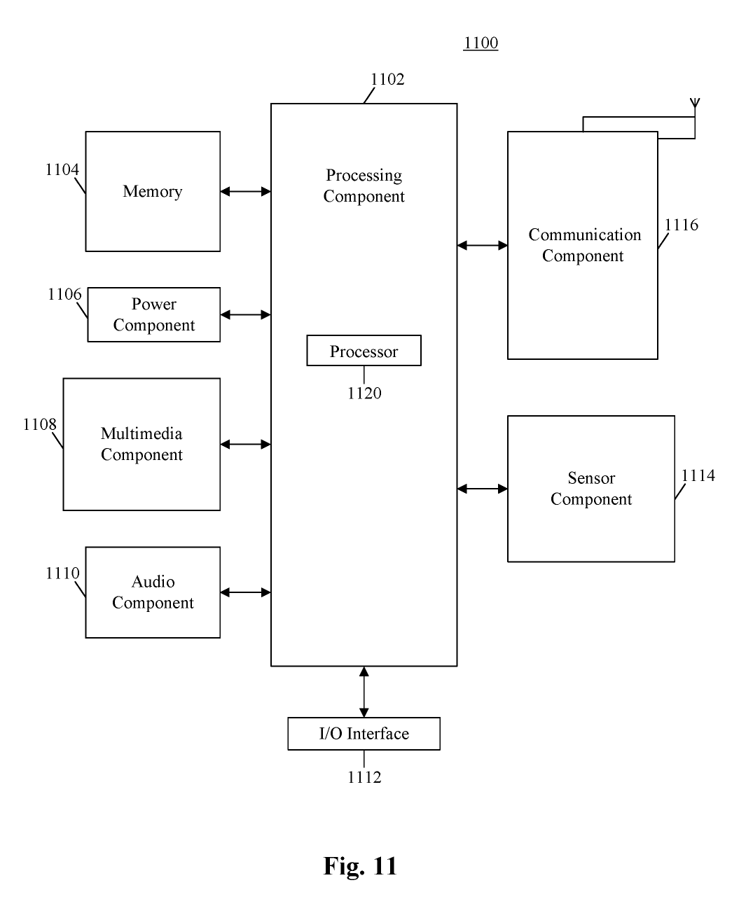

FIG. 11 is a block diagram showing a device 1100 for managing an alarm clock according to an illustrative embodiment. For example, the device 1100 may be an alarm clock, a mobile phone, a computer, a digital broadcast terminal, a message receiving and sending device, a gaming console, a tablet device, a medical device, exercise equipment, a personal digital assistant, and the like.

Referring to FIG. 11, the device 1100 includes one or more of the following components: a processing component 1102, a memory 1104, a power component 1106, a multimedia component 1108, an audio component 1110, an input/output (I/O) interface 1112, a sensor component 1114, and a communication component 1116.

The processing component 1102 typically controls overall operations of the device 1100, such as the operations associated with display, telephone calls, data communications, camera operations, and recording operations. The processing component 1102 may include one or more processors 1120 to execute instructions to perform all or part of the steps in the above described methods. Moreover, the processing component 1102 may include one or more modules which facilitate the interaction between the processing component 1102 and other components. For instance, the processing component 1102 may include a multimedia module to facilitate the interaction between the multimedia component 1108 and the processing component 1102.

The memory 1104 is configured to store various types of data to support the operation of the device 1100. Examples of such data include instructions for any applications or methods operated on the device 1100, contact data, phonebook data, messages, pictures, video, etc. The memory 1104 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 1106 provides power to various components of the device 1100. The power component 1106 may include a power management system, one or more power sources, and any other components associated with the generation, management, and distribution of power in the device 1100.

The multimedia component 1108 includes a screen providing an output interface between the device 1100 and the user. In some embodiments, the screen may include a liquid crystal display and a touch panel. If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 1108 includes a front camera and/or a rear camera. The front camera and/or the rear camera may receive an external multimedia datum while the device 1100 is in an operation mode, such as a photographing mode or a video mode. Each of the front camera and the rear camera may be a fixed optical lens system or have focus and optical zoom capability.

The audio component 1110 is configured to output and/or input audio signals. For example, the audio component 1110 includes a microphone configured to receive an external audio signal when the device 1100 is in an operation mode, such as a call mode, a recording mode, and a voice recognition mode. The received audio signal may be further stored in the memory 1104 or transmitted via the communication component 1116. In some embodiments, the audio component 1110 further includes a speaker to output audio signals.

The I/O interface 1112 provides an interface between the processing component 1102 and peripheral interface modules, such as a keyboard, a click wheel, buttons, and the like. The buttons may include, but are not limited to, a home button, a volume button, a starting button, and a locking button.

The sensor component 1114 includes one or more sensors to provide status assessments of various aspects of the device 1100. For instance, the sensor component 1114 may detect an open/closed status of the device 1100, relative positioning of components, e.g., the display and the keypad, of the device 1100, a change in position of the device 1100 or a component of the device 1100, a presence or absence of user contact with the device 1100, an orientation or an acceleration/deceleration of the device 1100, and a change in temperature of the device 1100. The sensor component 1114 may include a proximity sensor configured to detect the presence of nearby objects without any physical contact. The sensor component 1114 may also include a light sensor, such as a CMOS or CCD image sensor, for use in imaging applications. In some embodiments, the sensor component 1114 may also include an accelerometer sensor, a gyroscope sensor, a magnetic sensor, a pressure sensor, or a temperature sensor.

The communication component 1116 is configured to facilitate communication, wired or wirelessly, between the device 1100 and other devices. The device 1100 can access a wireless network based on a communication standard, such as WiFi, 2G; 3G; or 4G; or a combination thereof. In one illustrative embodiment, the communication component 1116 receives a broadcast signal or broadcast associated information from an external broadcast management system via a broadcast channel. In one illustrative embodiment, the communication component 1116 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In illustrative embodiments, the device 1100 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In illustrative embodiments, there is also provided a non-transitory computer-readable storage medium including instructions, such as included in the memory 1104, executable by the processor 1120 in the device 1100, for performing the above-described methods. For example, the non-transitory computer-readable storage medium may be a ROM, a RAM, a CD-ROM, a magnetic tape, a floppy disc, an optical data storage device, and the like.

Other embodiments of the disclosure will be apparent to those skilled in the art from consideration of the specification and practice of the disclosure disclosed here. This application is intended to cover any variations, uses, or adaptations of the disclosure following the general principles thereof and including such departures from the present disclosure as come within known or customary practice in the art. It is intended that the specification and examples be considered as illustrative only, with a true scope and spirit of the disclosure being indicated by the following claims.

One of ordinary skill in the art will understand that the above described modules/units can each be implemented by hardware, or software, or a combination of hardware and software. One of ordinary skill in the art will also understand that multiple ones of the above described modules/units may be combined as one module/unit, and each of the above described modules/units may be further divided into a plurality of submodules/subunits.

It will be appreciated that the present disclosure is not limited to the exact construction that has been described above and illustrated in the accompanying drawings, and that various modifications and changes can be made without departing from the scope thereof. It is intended that the scope of the disclosure only be limited by the appended claims.

What is claimed is:

1. A method for managing an alarm clock, comprising:
acquiring a movement of a user; and
cancelling a prompt preset in the alarm clock if the user is in a moving state when it is time to execute the prompt.

2. The method according to claim 1, wherein acquiring the movement of the user comprises:
detecting the movement of the user by a movement sensor disposed in the alarm clock.

3. The method according to claim 1, wherein acquiring the movement of the user comprises:
establishing a wireless communication with a device equipped with a movement sensor; and
receiving an indication of the movement of the user detected by the movement sensor via the wireless communication.

4. The method according to claim 3, wherein the device equipped with the movement sensor is a wearable device, and the movement sensor comprises a physiological parameter sensor.

5. The method according to claim 2, wherein the movement sensor comprises: an infrared sensor located adjacent to the user and having a receiving-and-sending window facing an area where the user is located.

6. The method according to claim 3, wherein the movement sensor comprises: an infrared sensor located adjacent to the user and having a receiving-and-sending window facing an area where the user is located.

7. The method according to claim 1, further comprising:
delaying the time to execute the prompt for a predetermined time period, and creating a corresponding delayed prompt; and
acquiring the movement of the user within the predetermined time period periodically, and cancelling the delayed prompt if the user is in the moving state within the predetermined time period.

8. A device for managing an alarm clock, comprising:
an acquiring unit, configured to acquire a movement of a user; and
a cancelling unit, configured to cancel a prompt preset in the alarm clock if the user is in a moving state when it is time to execute the prompt.

9. The device according to claim 8, wherein the acquiring unit comprises:
a detecting sub-unit, configured to detect the movement of the user by a movement sensor disposed in the alarm clock.

10. The device according to claim 8, wherein the acquiring unit comprises:
an establishing sub-unit, configured to establish a wireless communication with a device equipped with a movement sensor; and
a receiving sub-unit, configured to receive an indication of the movement of the user detected by the movement sensor via the wireless communication.

11. The device according to claim 10, wherein the device equipped with the movement sensor is a wearable device, and the movement sensor comprises a physiological parameter sensor.

12. The device according to claim 9, wherein the movement sensor comprises: an infrared sensor located adjacent to the user and having a receiving-and-sending window facing an area where the user is located.

13. The device according to claim 10, wherein the movement sensor comprises: an infrared sensor located adjacent to the user and having a receiving-and-sending window facing an area where the user is located.

14. The device according to claim 8, wherein the cancelling unit is a first cancellating unit, the device further comprising:
a creating unit, configured to delay the time to execute the prompt for a predetermined time period and create a corresponding delayed prompt; and
a second cancelling unit, configured to acquire the movement of the user within the predetermined time period periodically and cancel the delayed prompt if the user is in the moving state within the predetermined time period.

15. An electronic device, comprising:
a processor; and
a memory for storing instructions executable by the processor,
wherein the processor is configured to, when executing the instructions stored in the memory:
acquire a movement of a user; and
cancel a prompt preset in the alarm clock if the user is in a moving state when it is time to execute the prompt.

16. The electronic device according to claim 15, wherein the processor acquires the movement of the user by:
detecting the movement of the user by a movement sensor disposed in the alarm clock.

17. The electronic device according to claim 15, wherein the processor acquires the movement of the user by:
establishing a wireless communication with a device equipped with a movement sensor; and
receiving an indication of the movement of the user detected by the movement sensor via the wireless communication.

18. The electronic device according to claim 17, wherein the device equipped with the movement sensor is a wearable device, and the movement sensor comprises a physiological parameter sensor.

19. The electronic device according to claim 16, wherein the movement sensor comprises: an infrared sensor located adjacent to the user and having a receiving-and-sending window facing an area where the user is located.

20. The electronic device according to claim 17, wherein the movement sensor comprises: an infrared sensor located adjacent to the user and having a receiving-and-sending window facing an area where the user is located.
